(19) United States
(12) Patent Application Publication
(10) Pub. No.: US 2025/0076256 A1
(43) Pub. Date: Mar. 6, 2025

(54) Fluid Sensor

(71) Applicant: Tribosonics Limited, Sheffield (GB)

(72) Inventors: Philip Harper, Sheffield (GB); Samuel Joseph Hill, Sheffield (GB)

(21) Appl. No.: 18/570,965

(22) PCT Filed: Jun. 17, 2022
(86) PCT No.: PCT/GB2022/051549

§ 371 Date: Dec. 15, 2023

(30) Foreign Application Priority Data
Jun. 17, 2021 (GB) 2108643.4

(51) Int. Cl. G01N 29/024; G01N 9/24; G01N 29/028; G01N 29/22; G01N 29/24; G01N 29/30

(52) U.S. Cl. CPC G01N 29/024; G01N 9/24; G01N 29/028; G01N 29/222; G01N 29/2437; G01N 29/2468; G01N 29/30; G01N 2291/022; G01N 2291/02416; G01N 2291/02433; G01N 2291/02818

(57) ABSTRACT

A method for determining a property of a volume of fluid. The method comprises driving one or more transducers to generate i) a through-fluid acoustic wave having sufficiently high power to traverse into the volume of fluid, and ii) a reflective acoustic wave having sufficiently low power to be reflected at a reflection location located in between the volume of fluid and the one or more transducers generating the reflective acoustic wave. The method further comprises receiving, by the one or more transducers, both of the through-fluid acoustic wave and the reflective acoustic wave; converting the received waves into one or more corresponding electrical signals; and processing the one or more electrical signals to determine a property of the fluid.

### FIELD OF INVENTION

The invention relates to fluid sensors for monitoring properties of fluids.

### BACKGROUND

It is desirable to monitor properties of fluids, such as properties relating to substances or impurities contained within a fluid, which have a different composition and/or phase to the fluid. For example, it may be desirable to monitor the amount of/size of gas bubbles within a fluid. It may also be desirable to monitor the ratios of multiple different fluid substances which are mixed together or properties of the fluid such as density.

Known methods of monitoring properties of fluids suffer disadvantages such as requiring complex calibration or being limited in the types of property that are measurable.

### SUMMARY

According to a first aspect of the invention there is provided a method for determining a property of a volume of fluid. The method comprises driving one or more transducers to generate i) a through-fluid acoustic wave having sufficiently high power to traverse into the volume of fluid, and ii) a reflective acoustic wave having sufficiently low power to be reflected at a reflection location located in between the volume of fluid and the one or more transducers generating the reflective acoustic wave. The method further comprises receiving, by the one or more transducers, both of the through-fluid acoustic wave and the reflective acoustic wave; converting the received waves into one or more corresponding electrical signals; and processing the one or more electrical signals to determine a property of the fluid.

The through-fluid acoustic wave is typically generated by applying a relatively high-power electrical signal to a transducer, where the amplitude of the electrical signal may be in the region of 100 or 1000 volts. Such high power waves can penetrate relatively far into the fluid despite attenuation caused by the fluid. The reflective acoustic wave is typically generated by applying a lower power electrical signal to the same or a different transducer, where the amplitude of the lower power electrical signal may be in the region of 1 or 10 volts. Circuits or signal generators generating such low power waves via the transducers are highly stable and are less temperature dependent compared with the circuitry that is utilised to generate signals for the higher power through-fluid waves. Most of the energy of the reflective wave does not penetrate into the fluid, and is reflected before entering the fluid, although some energy of the reflective wave may penetrate the fluid and be reflected within the fluid. Use of both the through-fluid and reflective acoustic waves together provide an improved sensing function, since data obtained from both waves can be combined to provide an indication of a property of the fluid. In effect, the higher power through-fluid acoustic wave produces a measure of a property of the fluid (e.g. speed of sound) throughout the volume of fluid at a first level of accuracy. The lower power reflective wave produces another measure of a property of the fluid, which is not necessarily the same as the property measured by the through-fluid acoustic wave, (e.g. acoustic impedance) at a second level of accuracy that is greater than the first level. Using this method, a wide range of fluid properties can be measured, such as but not limited to: density, amount of dissolved gas, bubble size, aeration, degassing, bubble position etc.

Optionally, the acoustic waves are ultrasonic waves.

Ultrasonic waves may be waves at a frequency which is above the upper limit of human hearing. This upper limit varies from person to person, but is typically in the range of 15 to 20 KHz for human adults, or, just above 20 kHz for human infants. Sound produced above such frequencies may be referred to as ultrasound.

Optionally, the power of the through-fluid acoustic wave is at least one, two, or three times the order of magnitude of the power of the reflective acoustic wave.

Typically, the power of the generated waves is dependent on a voltage power input to an electric circuit which drives the transducer.

Optionally, the reflection location is a boundary of the volume of fluid.

Optionally, the reflective acoustic wave is generated within a solid volume, and wherein the boundary of the volume of fluid is a fluid-solid boundary between the volume of fluid and the solid volume.

Optionally, the processing comprises determining a reflection coefficient based on the electrical signal corresponding to the reflective acoustic wave; and, determining a time of flight based on the electrical signal corresponding to the through-fluid acoustic wave.

Optionally, the property of the fluid is an amount and/or volume of particles and/or bubbles located within a liquid phase of the fluid.

Optionally, the property of the fluid is density and/or acoustic impedance.

Optionally, driving the one or more transducers comprises driving a first transducer of the one or more transducers to generate the through-fluid acoustic wave; and, driving the second transducer of the one or more transducers to generate the reflective acoustic wave.

Optionally, the method further comprises receiving the through-fluid acoustic wave with the second transducer.

Optionally, driving the first transducer comprises driving the first transducer to transmit the through-fluid acoustic wave across the volume of the fluid to the second transducer.

Optionally, driving the first transducer comprises driving the first transducer to transmit the through-fluid acoustic wave to the second transducer via reflection of the through-fluid acoustic wave within the volume of fluid.

A particularly advantageous arrangement is to utilise two transducers, which are each mounted on opposing sides of a container of fluid e.g. a pipe through which the monitored fluid is flowing. One transducer transmits the higher power through-fluid waves, and the opposing transducer receives the higher power through-fluid waves. The opposing transducer also transmits and receives the lower power reflective waves which are reflected at or near the boundary of the fluid. Alternatively, the two transducers can be located adjacent to each other, and the higher power through-fluid wave is transmitted between the transducers via reflection within the fluid. Therefore, analysis using both of the higher and lower power waves can be undertaken using only two transducers, providing for any apparatus conducting the method to be compact and easy to use.

Optionally, the method further comprises sending an electronic pulse, by an electronic circuit of a controller, to drive the one or more transducers.

Optionally, the method further comprises driving the one or more transducers to transmit and/or receive the waves through a delay line configured to provide a time delay region for an acoustic wave to traverse between the transducer and the volume of fluid.

Optionally, the delay line is directly in contact with the fluid, or a barrier surrounding the volume of fluid.

The use of a delay line enables easy calibration of the system. For example, if the material properties of the delay line are known, then the time of flight of waves across the delay line can be measured to establish a baseline response.

Optionally, the method further comprises driving the one or more transducers to transmit and/or receive waves directly into the fluid, or into a barrier directly surrounding the volume of fluid.

Optionally, the method further comprises: driving the one or more transducers to pulse the through-fluid acoustic wave and the reflective acoustic wave in order that the waves are received at the same time; determining an interference between the received waves; and determining the property of the fluid based on the interference.

Optionally, the method further comprises driving the one or more transducers to generate the waves at different frequencies.

Optionally, the method further comprises driving the one or more transducers to generate and receive waves during a time period, and at a frequency of at least multiple times per second, and wherein the property of the fluid is determined based on a variation of the received waves during the time period.

According to a further aspect of the invention there is provided a fluid sensing apparatus for monitoring a volume of fluid, the fluid sensing apparatus configured to perform the method discussed above.

Optionally, the apparatus further comprises the one or more transducers, wherein the one or more transducers are piezoelectric transducers.

Optionally, the apparatus further comprises an electric circuit configured to drive the one or more transducers by sending an electronic pulse to the transducers.

According to a further aspect of the invention there is provided a computer-readable storage medium comprising instructions which, when executed by a processor, cause the fluid sensing apparatus comprising the processor to carry out the method discussed above.

The skilled person will appreciate that except where mutually exclusive, a feature described in relation to any one of the aspects, examples or embodiments described herein may be applied to any other aspect, example, embodiment or feature. Further, the description of any aspect, example or feature may form part of or the entirety of an embodiment of the invention as defined by the claims. Any of the examples described herein may be an example which embodies the invention defined by the claims and thus an embodiment of the invention.

### BRIEF OVERVIEW OF FIGURES

The invention will now be described, by way of example only, with reference to the accompanying drawings, in which:

FIG. 1 is a representation of a wave being transmitted and reflected through a fluid.

FIG. 2 shows example responses of the reflected wave of FIG. 1 in the time domain as observed by a receiving transducer.

FIG. 3 shows the example reflected waveforms of FIG. 1 in the frequency domain.

FIG. 4 shows an example schematic diagram of a first type of fluid sensing apparatus.

FIG. 5 shows an alternative example schematic diagram of a second type of fluid sensing apparatus.

FIG. 6 shows a first example arrangement of transducers with respect to a fluid to be measured.

FIG. 7 shows a second example arrangement of transducers with respect to a fluid to be measured.

FIG. 8 shows a third example arrangement of transducers with respect to a fluid to be measured.

FIG. 9 shows a fourth example arrangement of transducers with respect to a fluid to be measured.

FIG. 10 shows a fifth example arrangement of transducers with respect to a fluid to be measured.

FIG. 11 shows a sixth example arrangement of transducers with respect to a fluid to be measured.

FIG. 12 shows a plot of a typical relationship between reflection coefficient vs acoustic impedance of a fluid.

FIG. 13 shows a plot of an example received wave in the time domain as obtained using methods discussed in this disclosure.

FIG. 14 shows a plot of peak to peak amplitude vs time obtained during a test for measuring a number of bubbles in a fluid.

FIG. 15 shows a plot of peak to peak amplitude vs time obtained during a test for measuring the size of bubbles in a fluid.

FIG. 16 shows a plot of peak to peak signal (moving average) vs % volume of air in water obtained during a test.

FIG. 17 shows a flow diagram of a method according to this disclosure.

### DETAILED DESCRIPTION

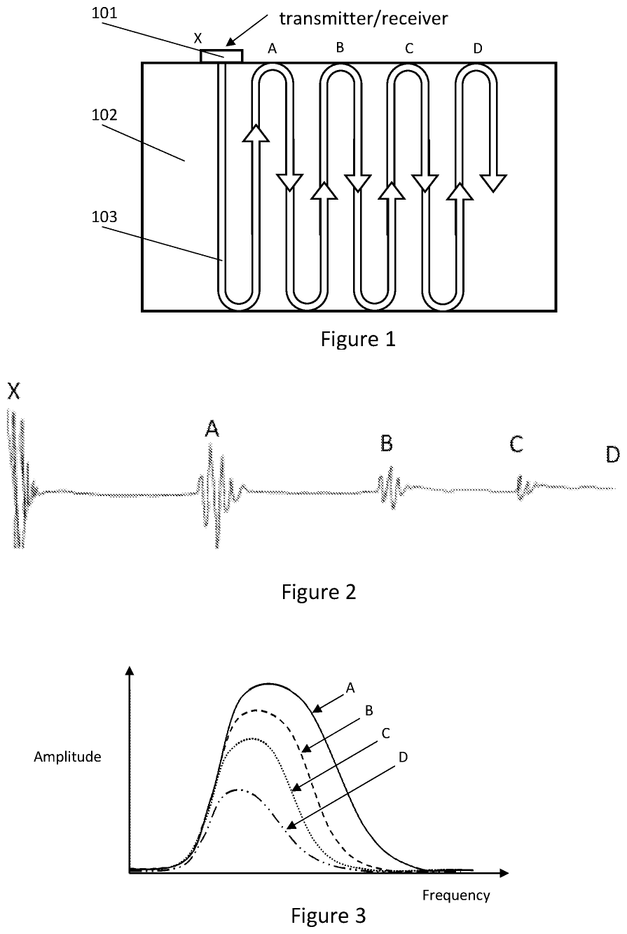

With reference to FIG. 1, a transducer 101 such as a piezoelectric ceramic transducer can be utilised to convert an electrical signal from an electric circuit (not shown) to an acoustic wave 103, and to transmit the acoustic wave 103 through a medium 102 at location X. This principle can be applied to media including solids, liquids, and gases. Any acoustic wave referred to in this disclosure may be an ultrasonic wave, i.e. an acoustic wave at a frequency beyond the upper limit of human hearing. The wave 103 is reflected at boundaries of the medium 102, and reflections of the wave are received at locations A, B, C and D. There is normally some transmission of the wave beyond the boundary of the medium 102 (i.e. a portion of the energy of the wave is not reflected at the boundary), although this is not shown. FIGS. 2 and 3 show an example measurement of the wave in the time and frequency domains respectively as observed at locations A, B, C and D. With reference to FIG. 3 in particular, it can be observed that there is less attenuation in the amplitude of lower frequency waves in comparison to higher frequency waves. It can be observed that the amplitude of the wave reduces for each reflection due to factors such as intrinsic attenuation including absorption and scattering, or, geometric attenuation due to beamspread (spread of the wave over distance) within the medium 102. Some properties of the medium 102 can be ascertained by observing levels of intrinsic and geometric attenuation in the fluid. Where the medium is a fluid, then example properties that can be ascertained in this manner include density or the existence of gas/other fluid bubbles within the fluid. Utilising these principles, properties of a medium such as a fluid can be determined by observation of such reflected waves. Some further properties of the fluid can depend on the speed at which the acoustic wave 103 travels through the fluid.

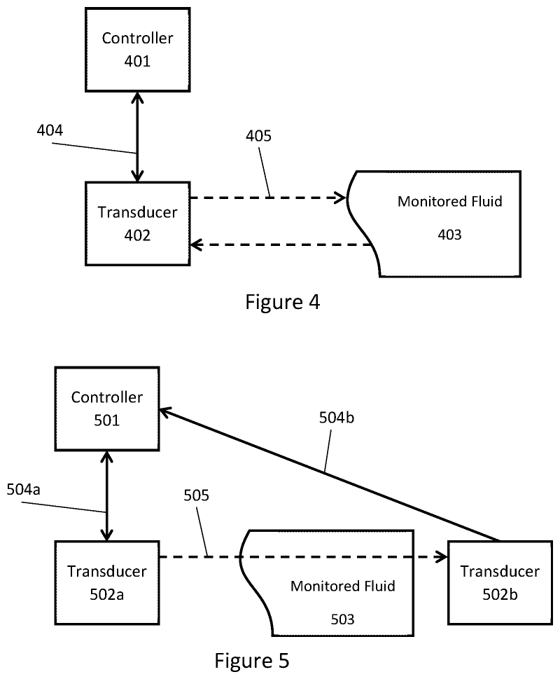

With reference to FIG. 4, a controller-transducer arrangement of the type that may be used with aspects of this disclosure is represented. The controller 401 generates an electrical signal, such as an electrical pulse, which is transmitted to the transducer 402 via an electrical connection 404. The controller 401 may comprise an electric circuit that generates the electrical signal. The electric circuit may be configured to generate the electrical signal by providing an alternating electrical current at a specified power as defined by the voltage (amplitude), and, frequency. It is preferable for the electric circuit to provide a stable electrical signal output over a range of temperatures where possible. Where the transducer is a piezoelectric transducer, the controller and electric circuit may be part of the same unit, and the electric signal is generated by supplying a voltage to an oscillator within the unit. The stability of the electric circuit (and sometimes the transducer itself) can be affected by temperature. Circuits configured to generate higher power signals tend to be more susceptible to temperature dependency in comparison to lower power signals. The transducer 402 converts the electrical signal into an acoustic wave 405, which is transmitted towards or into a monitored fluid 403. The acoustic wave has a particular power such that it is reflected at a reflection location, which in this example is a boundary of the fluid 403, and received back by the transducer 402. This type of acoustic wave is referred to herein as a reflective wave or reflective acoustic wave. The transducer 402 converts the received acoustic wave into a received electrical signal, which is transmitted back to the controller 401 via electrical connection 404. The controller 401 can process the received electrical signal to determine a reflection coefficient of the fluid 403 and thereby determine certain properties of the fluid 403. As used herein, the term “reflection coefficient” is a measure of how much power of the acoustic wave is reflected at the reflection location. Example properties of the fluid 403 that can be measured utilising the reflection coefficient include density and acoustic impedance.

With reference to FIG. 5, there is represented a controller-transducer arrangement that is typically combined with the arrangement of FIG. 4 in aspects of this disclosure, however it is drawn and described separately for clarity. The controller 501 generates an electrical signal, such as an electrical pulse, which is transmitted to the transducer 502a via an electrical connection 504a. The controller 501 may comprise an electric circuit for generating the electrical signal. A first transducer 502a converts the electrical signals into an acoustic wave 505. The acoustic wave 505 is transmitted through a fluid 503 to a second transducer 502b. The second transducer receives the acoustic wave 505 after it has travelled through the fluid 503. This type of acoustic wave is referred to herein as a through-fluid wave or through-fluid acoustic wave. The second transducer converts the received acoustic wave into a further electrical signal, which is transmitted to the controller 501 via electrical connection 504b. The controller 501 can process the received electrical signal to determine properties of the fluid 503. The properties of the fluid 503 will depend on how the wave has been affected during transmission through the fluid 503 and/or the time of flight of the wave through the fluid 503. For example, a slower time of flight may indicate the presence of gas bubbles within the fluid 503.

The controllers 401, 501 may each comprise an electric circuit configured to generate and receive the electrical signals at a predetermined power for driving the corresponding transducers 402, 502. A reflective wave, such as reflective wave 405 in FIG. 4, is generally of lower power than the through-fluid wave 505 of FIG. 5. This is because the through-fluid wave 505 must have a high enough power to traverse through the fluid 503. Electronic circuitry utilised to generate higher power waves is more susceptible to inaccuracies caused by the effect of varying temperature, in comparison with the circuitry generating signals for waves of lesser power. The circuitry for generating the signals for lower power waves tend to be more accurate and stable with temperature. However, lower power waves do not traverse as far into the fluid compared with higher power waves.

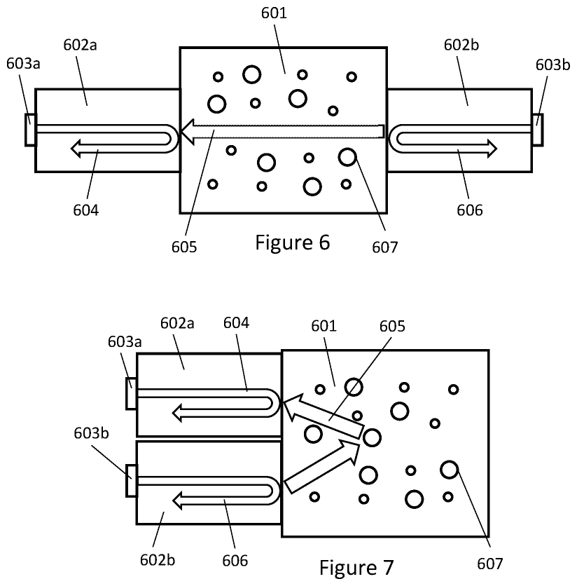

FIGS. 6 to 11 illustrate example arrangements for undertaking methods according to this disclosure.

With reference to FIG. 6, a first arrangement comprises a first transducer 603a and a second transducer 603b located on opposing sides of a volume of fluid 601. Each transducer is mounted on a corresponding first and second delay line 602a and 602b. The delay lines 602a, 602b are in contact with a fluid volume 601. That is, the fluid volume 601 is at least partially defined by the delay lines 602a, 602b, and a fluid-solid boundary exists at the interface of the fluid and the delay lines. Each transducer is electrically connected to one or more controllers (not shown). The transducers 603a, 603b may be each connected to the same controller, or to different controllers. The controllers may each comprise an electric circuit configured to generate electrical signals of predetermined power for driving the transducers 603a, 603b. The transducers 603a, 603b are configured to convert electrical signals from the one or more controllers into acoustic waves for transmission into the delay lines 602a, 602b. In other words, the one or more controllers drive the transducers 603a, 603b by providing electrical signals to the transducers. In operation, the first transducer 603a is driven to generate a reflective wave 604, which has a power level such that the reflective wave 604 is reflected at a boundary between the first delay line 602a and the fluid volume 601, and returned to the transducer 603a. The power level of the reflective wave 604 is high enough to cause the reflective wave to traverse the delay line 602a, yet low enough to prevent the wave from substantially entering the fluid volume 601. In some implementations, the reflective wave 604 is typically generated from an electrical signal having a voltage in the region of 1 to 10 volts. The second transducer 603b is driven to generate a through-fluid wave 605. The through-fluid wave 605 has more power than the reflective wave, and has sufficient power to travel through all of the delay lines 602a, 602b, and the fluid volume 601, in order to be received by the first transducer 603a. In some implementations, the through-fluid wave is typically generated from an electrical signal having a voltage in the region of 10 to 1000 volts. The second transducer 603b may, optionally, also generate an additional wave 606 for travelling through the second delay line 602b, and being reflected off the boundary between the second delay line 602b and the fluid volume 601, to be received by the second transducer 603b. The additional wave 606 is typically generated at a similar power to the reflective wave 604. The transducers 603a, 603b convert the received waves into electrical signals for transmission to the one or more controllers for processing.

Processing of the received reflective wave 604 provides measurements such as a reflection coefficient of the volume of fluid 601. The measurement from the reflective wave are highly accurate and reliable, even over a range of temperatures that the circuitry generating the signal for the reflective wave are subject to. This is because circuitry configured to generate lower power signals for lower power waves is relatively stable over varying temperatures. Processing of the received through-fluid wave 605 provides measurements such as a time of flight through the volume of fluid 601. The measurements from the through-fluid wave 605 provide an indication of properties across the entire volume of fluid 601. For example, the time of flight measurement can be utilised to provide an indication of a number and/or size of bubbles 607 within the volume of fluid 601. Circuitry configured to generate higher power signals for the through-fluid wave 605 can be more susceptible to inaccuracies due to temperature fluctuation. However, these effects are advantageously mitigated by utilising both measurements of the through-fluid wave 605 and measurements obtained by the lower power reflective wave 604. The reflective wave 604 and additional reflective wave 606 can be utilised to obtain measurements such as time of flight measurements through the first and second delay lines 602a, 602b, respectively, thereby enabling calibration of the system based on known properties (e.g., material properties) of the delay lines.

The purpose of the delay lines 602a, 602b is to act as a conduit of acoustic energy from the transducer to the fluid 601. In order for this transfer to be efficient, and for any measurements to be reliable, the delay lines may have several characteristics. The acoustic impedance of the delay lines 602a, 602b are preferably not too high such that there is minimal sensitivity in the measurement of fluids, or, too low that there is a limit in the measurement range of the acoustic impedance of the fluid 601. Ideally, the acoustic impedance of the delay line is such that a parameter such as the reflection coefficient of the fluid 601 measurably varies across an expected range of the acoustic impedance of the fluid 601. The delay lines 602a, 602b preferably have an acoustic impedance that is known to a high degree of certainty. The delay lines 602a, 602 further preferable have a low acoustic velocity for reducing beamspread, which is the degree by which the acoustic wave spreads within the delay lines 602a, 602b. A reduced beamspread enables the width of the delay line (i.e. distance traversed by the wave through the delay line) to be smaller, thereby enabling more compact packaging of the delay line 602a, 602b. It is further desirable for the delay lines 602a, 602b to have stable material properties with respect to environmental conditions, particularly temperature. Temperature unstable material properties of any delay line may adversely affect the accuracy of measurements. The delay lines 602a, 602b also serve to provide a time delay between excitation of the transducers 603a 603b and receipt of the reflected waves 604, 606, thereby preventing mixing of the transmitted and reflected signals at the transducers.

With reference to FIG. 7, there is shown a second arrangement comprising the same referenced features as FIG. 6. The arrangement of FIG. 7 differs from the arrangement of FIG. 6 in that the first and second transducers/delay lines are located adjacent one another on the same side of the volume of fluid 601. The through-fluid wave 605 is transmitted between the second and first transducers 603b, 603a, via reflection within the volume of fluid 601. The through-fluid wave 605 of FIG. 7 typically has a reduced power compared to the through-fluid wave 605 of FIG. 6, if all other factors were the same, in order to penetrate partly (and not wholly) through the fluid 601. The arrangement of FIG. 7 is particularly advantageous where it is desirable for measurement apparatus comprising the transducers to be formed within a compact package that is easy to place in situ.

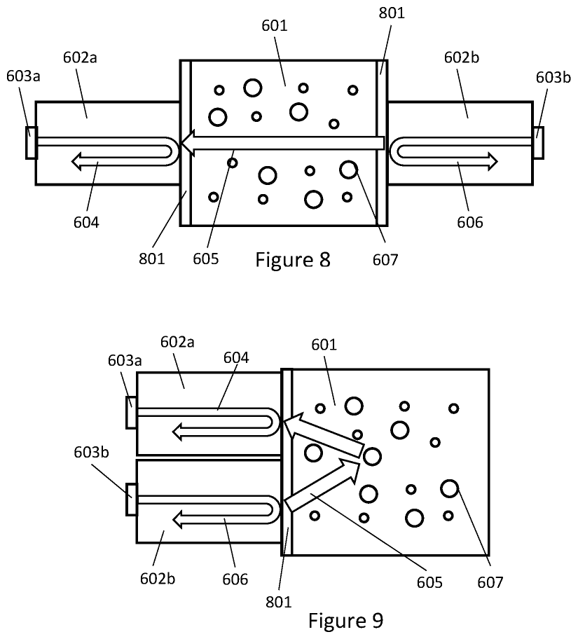

With reference to FIG. 8, there is shown a third arrangement comprising the same referenced features as FIG. 6. The arrangement of FIG. 8 differs from the arrangement of FIG. 6 in that there is additionally a separation wall 801 between the delay lines 602a, 602b, and the volume of fluid 601. The separation wall 801 may be the walls of a pipe containing a flowing volume of fluid 601, or the walls of a container which contains the volume of fluid 601. The reflective wave 604 and additional wave 606 reflect at the boundary between the delay lines 602a, 602b, and the wall 801. Reflection of the reflective wave 604 at the boundary between the delay line 602a and the wall 801 enables calibration of the method, for example, to account for the variation of speed of sound (i.e. time of flight of the wave) through the delay line 602a depending on temperature.

With reference to FIG. 9, there is shown a fourth arrangement comprising the same referenced features as FIG. 8. The arrangement of FIG. 9 differs from the arrangement of FIG. 8 in that the first and second transducers/delay lines are located adjacent one another on the same side of the volume of fluid 601, in a similar manner to the transducers/delay lines of FIG. 7. The arrangement of FIG. 9 is particularly advantageous where it is desirable for a measurement apparatus comprising the transducers to be formed within a compact package that is easy to place in situ. The through-fluid wave 605 is transmitted between the second and first transducers 603b, 603a, via reflection within the volume of fluid 601.

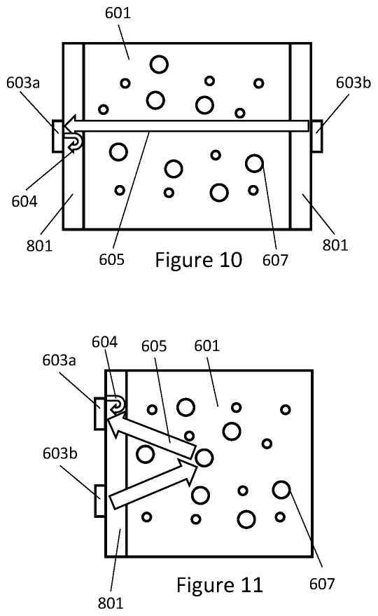

With reference to FIG. 10, there is shown a fifth arrangement comprising some features corresponding to those referenced above. In contrast to the previously discussed arrangements, the transducers 603a, 603b are directly mounted on the separation wall 801. Such direct mounting of the transducers 603a, 603b (i.e. omission of the delay line as discussed above), simplifies, and reduces the size and cost of, the arrangement. For example, no modification to the pipe wall 801 is necessary for mounting a delay line being in direct contact with the fluid. The wall 801 can be utilised in a similar manner as a delay line. The reflective wave 604 is transmitted directly into the separation wall 801 and is reflected on the boundary between the separation all 801 and the volume of fluid 601. The through-fluid wave 605 is transmitted across the separation wall 801 and volume of fluid 601, from the second transducer 603b, to the second transducer 603a.

With reference to FIG. 11, there is shown a sixth arrangement comprising features corresponding to FIG. 10. The arrangement of FIG. 11 differs from the arrangement of FIG. 10 in that the first and second transducers 603a, 603b are located adjacent one another on the same side of the volume of fluid 601. The through-fluid wave 605 is transmitted between the second and first transducers 603b, 603a, via reflection within the volume of fluid 601.

Example properties that are measured using the above described principles include a gas bubble size in a fluid, a number of gas bubbles in a fluid, a mix ratio of different fluid substances, an amount of dissolved gas in a fluid, a level of aeration in a fluid, foreign particle distribution in a fluid, for example, a measurement of an amount of oil within melted wax. A further example is the detection of contamination of a polymeric fluid flow with different types of polymers, in particular, for improving polymer sorting during processing for recycling.

The above examples utilise two transducers. However, this disclosure contemplates the use of one single transducer, or more than two transducers. A single transducer may be utilised to generate and receive both of the through-fluid and reflective waves. For example, where there is a single transducer, the through-fluid wave may be reflected back to the single transducer within a volume of fluid, and the reflective wave may be reflected back to the single transducer at a boundary of a volume of fluid. Where a single transducer is utilised, the single transducer may be electrically connected to both of a high power circuit, and a low power circuit for higher accuracy. The high and low power circuits may each comprise separate transmission and receive circuits. One receive circuit may have a lower gain than the other, for high precision measurement of the reflective wave, and, the other receive circuit may have a higher gain for receiving higher power through-fluid waves. Any of the receive circuits may have a fixed or variable gain. More than two transducers may be utilised to transmit different ones or both of through-fluid and reflective waves to each other. Multiple pairs of transducers may be utilised to monitor the properties of fluids at multiple locations, for example, along a pipe. All of the transducers in an arrangement may be electrically connected to a single (i.e. shared) controller, or each controller in the arrangement may be connected to a corresponding controller. The controller may be a computing device or a general purpose signal generator. The controller may comprise an electric circuit configured to generate signals for driving the transducers. Any electric circuit may be constructed in order to output electric signals at a voltage level, which is proportional to the power level of the generated waves, suitable for driving transducers to output a reflective or through-fluid wave as discussed herein.

The electrical signals derived from the received waves can be used to determine various variables for ascertaining properties of the fluid under measurement. Example variables include a change in amplitude between the generated and received waves (for determining a reflection coefficient and/or amount of attenuation), time of flight of the generated wave through the fluid, amount of background scatter (e.g. caused by small reflections from reflectors in the fluid such as air bubbles), amplitude change indicating a change in frequency, phase change indicating a change in frequency.

Typically, an electrical pulse signal is used to drive the transducers. Electric circuits within controllers are typically used to generate the pulse signals. The controllers may be configured to issue pulses for driving transducers to produce reflective and through-fluid waves so that the resulting received waves are arrive at a receiving transducer at the same time. A degree of interference between the waves can be determined and used to detect changes in the fluid.

The through-fluid and reflective waves may be generated at different frequencies. The range of frequencies of the through-fluid and reflective waves may be from 100 kHz to 25 MHz. For example, the reflective wave may be generated at a frequency of 2.25 MHz. The through-fluid wave may be generated at 2.25, 1, or 0.5 MHz. Varying the frequency of the waves may provide information relating to a frequency dependency of attenuation through the fluid, and in turn, provide information relating to any gas bubble size or distribution. The controller may be configured to drive the transducers to pulse the through-fluid and reflective waves multiple times per second, for example at 10 KHz (10,000 pulsing and receiving cycles per second), or even 20 kHz, 50 kHz, or 100 KHz. This provides dynamic ‘real-time’ information from a fluid. How the signals from the received waves varies over time indicates properties of the fluid. Example properties of the wave that may vary with time include amplitude (from a reflection coefficient or due to attenuation) and time of flight. An artificial intelligence or machine learning tool may be trained/utilised to determine fluid properties based on different types of signals from the received waves.

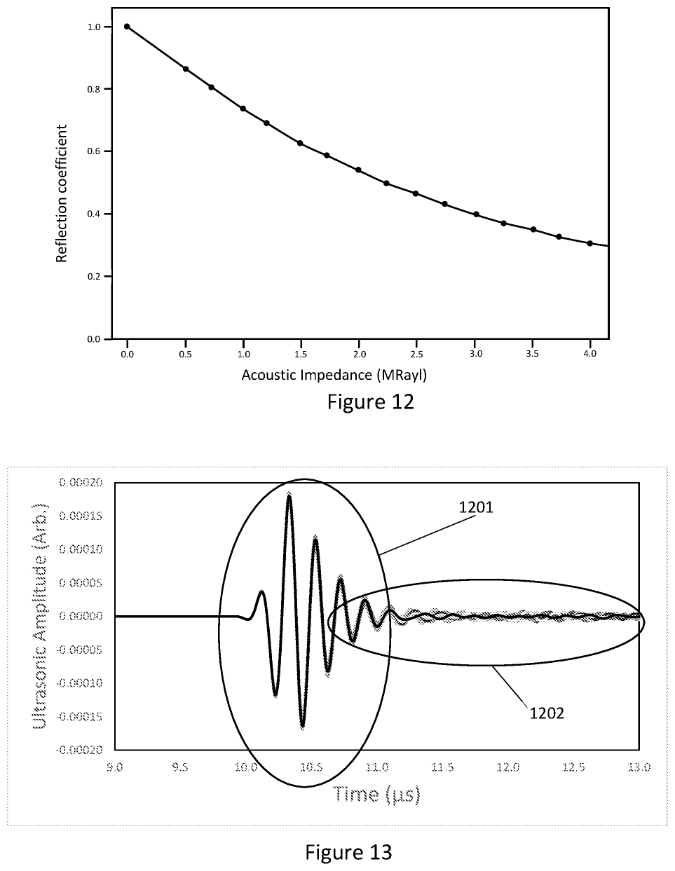

An analysis of reflection coefficient and backscatter of a received wave may be utilised for determining a property of a fluid, in combination with the principles discussed above. FIG. 12 shows an example relationship between the reflection coefficient and acoustic impedance of a fluid. FIG. 13 shows an example plot of received reflective waves obtained using the principles discussed herein. Where an arrangement includes a delay line, then the received wave is typically measured at an end of the delay line (by an adjacent transducer). The region bounded by ellipse 1201 contains the reflection of the reflective wave from the boundary between the delay line and the fluid. The reflection coefficient can be obtained by calculating the signal energy in region 1201. This calculation provides a highly accurate and stable measurement of the reflection coefficient, from which can be derived a value of the acoustic impedance of the fluid close to a boundary of the fluid where the reflective wave has been reflected, for example, by utilising the relationship shown in FIG. 12. The region bounded by ellipse 1202 contains echoes reflected from gas bubbles within the fluid, thereby being indicative of a parameter relating to the bubble content of the fluid.

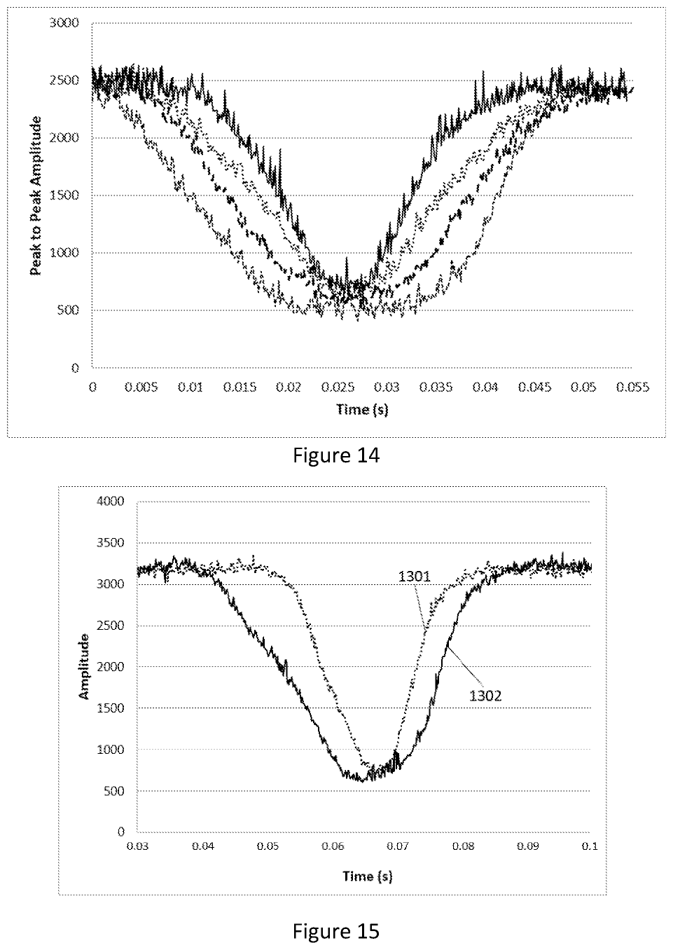

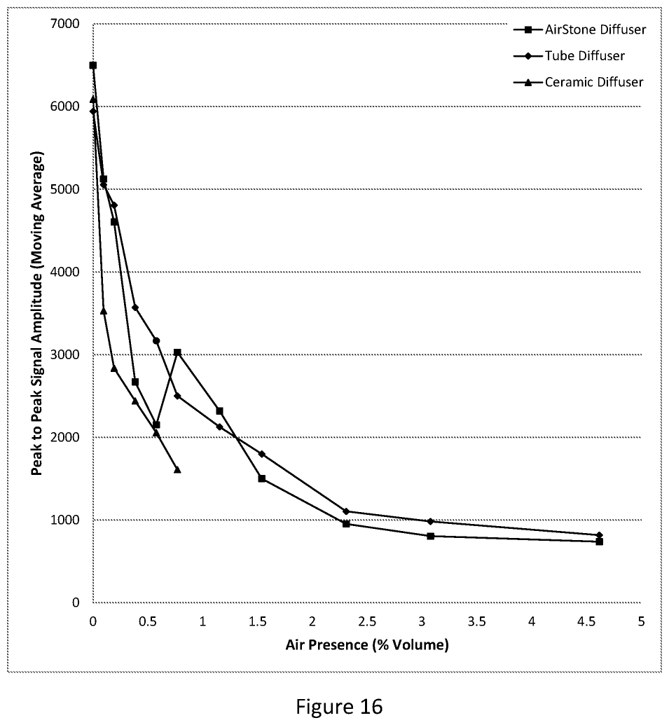

Test results indicating the effectiveness of the discussed principles relating to the use of through-fluid waves are shown in FIGS. 14 to 16. FIG. 14 shows a plot of peak to peak amplitudes over time for received through-fluid waves, as obtained during the passage of successive bubbles. It can be observed that a passing bubble can be detected based on a ‘U’ curve of the plot. FIG. 15 indicates similar curves to those of FIG. 14, but for only two bubbles as identified using a high speed camera. Curve 1301 corresponds to a bubble having a 1.2 mm hole, and curve 1302 corresponds to a bubble having a 0.4 mm hole. Therefore, it is possible to determine a bubble size based on peak-to-peak amplitudes of the received through-fluid waves. FIG. 16 indicates a correlation between a moving average of the peak to peak amplitude of the received wave, and a proportion of air in a volume of water.

Combining the results of tests utilising both reflective and through-fluid waves such as those discussed with respect to FIGS. 13 to 15 can be used to obtain a breadth of information about gas bubbles within fluids. For example, the reflective wave provides information about fluid properties, and, the position of bubbles in the fluid, whilst the higher powered through-fluid wave provides sizing information about the bubbles. Determination of the fluid properties complements information about the bubbles in order to interpret bubble data in terms of the physics of a particular fluid setup. Additional measurements of the phasing between reflective and through-fluid waves may provide further relevant information.

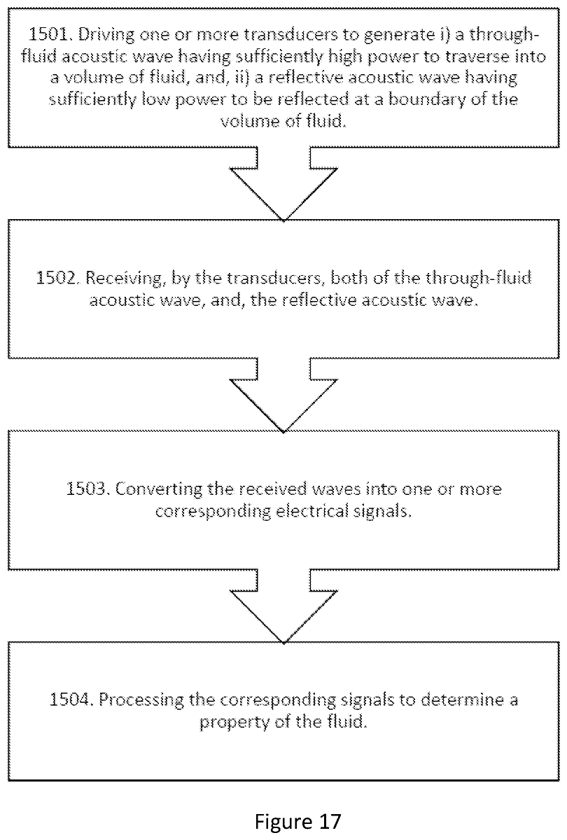

FIG. 17 shows a process flow diagram of a method according to this disclosure. During step 1501, one or more transducers are driven, typically by a controller, to generate i) a through-fluid acoustic wave having sufficiently high power to traverse into the volume of fluid, and ii) a reflective acoustic wave having sufficiently low power to be reflected at a boundary of the volume of fluid. During step 1502, the transducers receive, both of the through-fluid acoustic wave, and the reflective acoustic wave. During step 1503, the received waves are converted into one or more corresponding electrical signals. During step 1504, the corresponding signals are processed to determine a property of the fluid.

In examples, a method for monitoring a fluid may be undertaken by the following steps, in the order presented, or in a different order. An acoustic wave is generated by sending a low voltage pulse to a transducer, the reflective acoustic wave being transmitted by the transducer to an interface between a separating wall and a fluid volume, where the fluid volume is contained behind the separating wall. As used herein, the term “low voltage” refers to a voltage in the region of 1 to 10 volts, or sufficiently low to generate a reflective wave that does not penetrate a fluid volume. The reflective wave may be generated to be transmitted through a delay line and a fluid containment wall, or only through a fluid containment wall. A reflection of the reflective wave is received by the same transmitting transducer, or another receiving transducer, by measuring a received voltage signal.

Information is extracted from the received signal that is relevant for the fluid being monitored (e.g. detecting particles or air bubbles that are not part of the fluid but contained within the fluid, and/or detecting properties of the fluid that are intrinsic to the fluid—e.g. density or acoustic impedance). A high voltage pulse is sent to the transducer, or a different additional transducer. As used herein, the term “high voltage” refers to a voltage in the region of 100 to 1000 volts, or sufficiently high to generate a through-fluid wave that substantially penetrates the fluid volume. The through-fluid wave is received by the transducer that emitted the reflective acoustic wave, and a corresponding voltage signal is obtained. Information is extracted from the received through-fluid acoustic waveform that is relevant for the measured fluid e.g. detection of particles or gas bubbles.

It will be understood that the invention is not limited to the examples and embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method for determining a property of a volume of fluid, the method comprising:
driving one or more transducers to generate i) a through-fluid acoustic wave having sufficiently high power to traverse into the volume of fluid, and ii) a reflective acoustic wave having sufficiently low power to be reflected at a reflection location located in between the volume of fluid and the one or more transducers generating the reflective acoustic wave;
receiving, by the one or more transducers, both of the through-fluid acoustic wave and the reflective acoustic wave;
converting the received waves into one or more corresponding electrical signals; and
processing the one or more electrical signals to determine a property of the fluid.

2. The method of claim 1, wherein the acoustic waves are ultrasonic waves.

3. The method of claim 1, wherein the power of the through-fluid acoustic wave is at least one, two, or three times the order of magnitude of the power of the reflective acoustic wave.

4. The method of claim 1, wherein the reflection location is a boundary of the volume of fluid.

5. The method of claim 4, wherein the reflective acoustic wave is generated within a solid volume, and wherein the boundary of the volume of fluid is a fluid-solid boundary between the volume of fluid and the solid volume.

6. The method of claim 1, wherein the processing comprises:
determining a reflection coefficient based on the electrical signal corresponding to the reflective acoustic wave; and
determining a time of flight based on the electrical signal corresponding to the through-fluid acoustic wave.

7. The method of claim 1, wherein the property of the fluid is an amount and/or volume of particles and/or bubbles located within a liquid phase of the fluid.

8. The method of claim 1, wherein the property of the fluid is density and/or acoustic impedance.

9. The method of claim 1, wherein driving the one or more transducers comprises:
driving a first transducer of the one or more transducers to generate the through-fluid acoustic wave; and
driving a second transducer of the one or more transducers to generate the reflective acoustic wave.

10. The method of claim 9, further comprising receiving the through-fluid acoustic wave with the second transducer.

11. The method of claim 10, wherein driving the first transducer comprises driving the first transducer to transmit the through-fluid acoustic wave across the volume of the fluid to the second transducer.

12. The method according to claim 10, wherein driving the first transducer comprises:
driving the first transducer to transmit the through-fluid acoustic wave to the second transducer via reflection of the through-fluid acoustic wave within the volume of fluid.

13. The method of claim 1, further comprising sending an electronic pulse, by an electronic circuit of a controller, to drive the one or more transducers.

14. The method of claim 1, comprising wherein driving the one or more transducers comprises:
driving the one or more transducers to transmit and/or receive the waves through a delay line configured to provide a time delay region for an acoustic wave to traverse between the transducer and the volume of fluid.

15. The method of claim 14, wherein the delay line is directly in contact with the fluid, or a barrier surrounding the volume of fluid.

16. The method of claim 1, wherein driving the one or more transducers comprises:
driving the one or more transducers to transmit and/or receive waves directly into the fluid, or into a barrier directly surrounding the volume of fluid.

17. The method of claim 1, further comprising:
driving the one or more transducers to pulse the through-fluid acoustic wave and the reflective acoustic wave in order that the waves are received at the same time;
determining an interference between the received waves; and
determining the property of the fluid based on the interference.

18. The method of claim 1, wherein driving the one or more transducers comprises:
driving the one or more transducers to generate the waves at different frequencies.

19. The method of claim 1, wherein driving the one or more transducers comprises:
driving the one or more transducers to generate and receive waves during a time period, and at a frequency of at least multiple times per second, and wherein the property of the fluid is determined based on a variation of the received waves during the time period.

20. The fluid sensing apparatus for monitoring a volume of fluid, the fluid sensing apparatus comprising:
one or more transducers configured to:
generate a through-fluid acoustic wave having sufficiently high power to traverse into the volume of fluid,
generate a reflective acoustic wave having sufficiently low power to be reflected at a reflection location located in between the volume of fluid and the one or more transducers generating the reflective acoustic wave,
receive both of the through-fluid acoustic wave and the reflective acoustic wave, and
convert the received waves into one or more corresponding electrical signals; and
a controller configured to process the one or more electrical signals to determine a property of the fluid.

21. (canceled)

22. (canceled)

23. (canceled)
